(19) United States
(12) Patent Application Publication
(10) Pub. No.: US 2014/0119670 A1
(43) Pub. Date: May 1, 2014

(54) ENCODING APPARATUS, DECODING APPARATUS, ENCODING METHOD, AND DECODING METHOD

(71) Applicant: Sony Corporation, Tokyo (JP)

(72) Inventor: Hiroshi ARAI, Kanagawa (JP)

(73) Assignee: Sony Corporation, Tokyo (JP)

(21) Appl. No.: 14/061,014

(22) Filed: Oct. 23, 2013

(30) Foreign Application Priority Data
Oct. 29, 2012 (JP) 2012-238135

(51) Int. Cl. G06T 3/40

(52) U.S. Cl. CPC G06T 3/4092
USPC 382/233; 382/232

(57) ABSTRACT

An encoding apparatus includes: a base image generation unit to down-convert an input image at a predetermined first magnification to generate a base image; a first image component generation unit to generate first image component information, the first image component information being used to down-convert the input image at a predetermined second magnification different from the first magnification and being part of information used to restore the input image from the base image; a second image component generation unit to generate second image component information, the second image component information being used to down-convert the input image at a predetermined third magnification different from the first magnification and the second magnification and being used together with the first image component information to restore the input image from the base image; and an output unit to output the base image, the first image component information, and the second image component information.

### CROSS REFERENCE TO RELATED APPLICATIONS

This application claims the benefit of Japanese Priority Patent Application JP 2012-238135 filed Oct. 29, 2012, the entire contents of which are incorporated herein by reference.

### BACKGROUND

The present disclosure relates to an encoding apparatus and a decoding apparatus that are suitable for transmission of image data with a plurality of resolutions.

In recent years, along with the progress in high-resolution television broadcasting, high-resolution images such as 4K high-definition images and 8K ultra high-definition images have been increasingly used. Further, along with the progress in portable terminals such as smartphones, a demand to display images with various resolutions from high resolution to low resolution has been increasing.

Further, it is currently general to use wavelet transform to compress and transmit high-resolution images.

It has been said, that wavelet transform/inverse transform in related art is allowed to reduce or increase resolution (i.e., scaling) by using only a power of 2 in terms of the nature thereof. However, for example, it is thought that a demand for decoding by resolution other than the power of 2 is increasing if the resolution of an original image becomes large. Specifically, it is thought that if decoding can be performed at resolutions of any optional rational numbers including not only the power of 2 but also other resolutions, the limiting conditions of terminals do not have influence any more, which widens application purposes.

In this regard, for example, in a wavelet decoding apparatus disclosed in Japanese Patent Application Laid-open No. 2000-125294, a wavelet inverse transform section, includes an up-sampler, a down-sampler, and a composite filter that are arranged adaptively according to a prescribed resolution transform magnification to achieve a resolution transform function at a magnification of an optional rational number. It should be noted that in the following description, instead of the terms of “up-sampler” and “down-sampler”, the terms of “upconverter (up-convert)” and “down-converter (down-convert)” are used as names of mechanisms to perform resolution transform.

### SUMMARY

In the decoding apparatus disclosed in Japanese Patent Application Laid-open No. 2000-125294, it is assumed that an image to be input is a wavelet-transformed image. In the case where the image is decoded, by wavelet inverse transform in the decoding apparatus, two types of inverse transform, i.e., inverse transform in a vertical direction and inverse transform in a horizontal direction have to be performed. Additionally, an intermediate image at a stage where one type of the inverse transform has been performed is a dull image in a longitudinal direction or a lateral direction, and therefore the image is not output to be used as it is. As described above, in the decoding apparatus and the like, the resolution or the quality of an image to be obtained is limited, and besides, improvement in various aspects is expected.

In view of the circumstances as described above, it is desirable to provide an encoding apparatus, a decoding apparatus, an encoding method, and a decoding method, with which images with resolutions variously changed by simple calculations can be used.

(1) According to an embodiment of the present disclosure, there is provided an encoding apparatus including a base image generation unit, a first image component generation unit, a second image component generation unit, and an output unit. The base image generation unit is configured to down-convert an input image at a predetermined first magnification to generate a base image. The first image component generation unit is configured to generate first image component information, the first image component information being used to down-convert the input image at a predetermined second magnification that is different from the first magnification and being part of information used to restore the input image from the base image. The second image component generation unit is configured to generate second image component information, the second image component information being used to down-convert the input image at a predetermined third magnification that is different from the first magnification and the second magnification and being used together with the first image component information to restore the input image from the base image. The output unit is configured to output the base image, the first image component information, and the second image component information.

In the embodiment of the present disclosure, images with a total of four resolutions, i.e., three images obtained by down-converting the input image at the first magnification, the second magnification, and the third magnification and the original input image, are output in the decoding apparatus. For that reason, in the encoding apparatus, only three components, i.e., the base image, the first image component information, and the second image component information, are generated and transmitted to the decoding apparatus. Those components can be generated by simple calculations and used to obtain the original input image and the three images down-converted by the simple calculations. Therefore, in the encoding apparatus and the decoding apparatus according to embodiments of the present disclosure, images with resolutions variously changed by simple calculations can be used.

(2) The encoding apparatus according to the embodiment of the present disclosure may further include a coding unit configured to calculate a first offset value between the first image component information and each pixel of the base image to code the first offset value, and calculate a second offset value between the second image component information and each pixel of the base image to code the second offset value, in which the output unit may be configured to output the base image, the coded first offset value, and the coded second offset value.

In the embodiment of the present disclosure, differences between each pixel value of the base image and a value of the first image component information and between each pixel value, of the base image and a value of the second image component information, i.e., offset, values are calculated. The offset values calculated herein are zero in many cases. Therefore, coding of the offset values allows an effective compression.

(3) The encoding apparatus according to the embodiment of the present disclosure may further include an image quality adjustment unit configured to uniformly adjusting an image quality for all pixels of the base image, in which the coding unit may be configured to calculate the first offset value and the second offset, value from the base image with an adjusted image quality.

In the case where the image quality of the input image is adjusted in the embodiment of the present disclosure, the image quality adjustment is performed, on only the base image not at the time of the input of the Image but at the time of the generation of the base image. The effect of the image quality adjustment that has been performed on only the base image is reflected on images with any resolutions to be output from the decoding apparatus through the offset calculations. Therefore, the number of pixels to be a target of the image quality adjustment can be reduced.

(4) In the encoding apparatus according to the embodiment of the present, disclosure, the input image may have a vertical resolution of 2160, the first magnification may be ⅓-fold, the second magnification may be ½-fold, and the third magnification may be ⅔-fold.

(5) According to an embodiment of the present disclosure, there is provided a decoding apparatus including an input unit and an output unit. The input unit is configured to input a base image obtained by down-converting an original image at a predetermined first magnification, first image component information used to down-convert the original image at a predetermined second magnification that is different from the first magnification, the first image component information being part of information used to restore the original image from the base image, and second image component information used to down-convert the original image at a predetermined third magnification that is different from the first magnification and the second magnification, the second image component information being used together with the first image component information to restore the original image from the base image. The output unit is configured to output the input base image.

In the embodiment of the present disclosure, the base image can be taken out from the base image, the first image component information, and the second image component information, which are input into the decoding apparatus, by simple configurations and processing.

(6) In the decoding apparatus according to the embodiment of the present disclosure, a base image output from the output unit may have a vertical resolution of 720.

(7) According to an embodiment of the present disclosure, there is provided a decoding apparatus including an input unit, a down-conversion unit, and an output unit. The input unit is configured to input a base image obtained by down-converting an original image at a predetermined first magnification, first image component information used to down-convert the original image at a predetermined second magnification that is different from the first magnification, the first image component information being part of information, used to restore the original image from the base image, and second image component information used to down-convert the original image at a predetermined third magnification that is different from the first magnification and the second magnification, the second image component information being used together with the first image component information to restore the original image from the base image. The down-conversion unit is configured to generate a down-converted image corresponding to the original image down-converted at the second magnification by using the input first image component information. The output unit is configured to output the down-converted image.

In the embodiment of the present disclosure, the down-converted image at the second magnification can be taken out from the base image, the first image component information, and the second image component information, which are input into the decoding apparatus, by simple calculations.

(8) In the decoding apparatus according to the embodiment of the present disclosure, an image output from the output unit may have a vertical resolution of 1080.

(9) According to an embodiment of the present disclosure, there is provided a decoding apparatus including an input unit, a down-conversion unit, and an output unit. The input unit is configured to input a base image obtained by down-converting an original image at a predetermined first magnification, first image component information used to down-convert the original image at a predetermined second magnification that is different from the first magnification, the first image component information being part of information used to restore the original image from the base image, and second image component information used to down-convert the original image at a predetermined third magnification that is different from the first magnification and the second magnification, the second, image component information being used together with the first image component information to restore the original image from the base image. The down-conversion unit is configured to generate a down-converted image corresponding to the original image down-converted at the third magnification by using the input base image and the input second image component information. The output unit is configured to output the down-converted image.

In the embodiment of the present disclosure, the down-converted image at the third magnification can be taken out from the base image, the first image component information, and the second image component information, which are input into the decoding apparatus, by simple calculations.

(10) In the decoding apparatus according to the embodiment of the present disclosure, an image output from the output unit may have a vertical resolution of 1440.

(11) According to an embodiment of the present disclosure, there is provided a decoding apparatus including an input unit, a restoration unit, and an output unit. The input unit is configured to input a base image obtained by down-converting an original image at a predetermined first magnification, first image component information used to down-convert the original image at a predetermined second magnification that is different from the first magnification, the first image component information being part, of information used to restore the original image from the base image, and second image component information used to down-convert the original image at a predetermined third magnification that is different from the first magnification and the second magnification, the second image component information being used together with the first image component information to restore the original image from the base image. The restoration unit is configured to restore the original image by using the input base image, the input first image component information, and the input second image component information. The output unit is configured to output the restored original image.

In the embodiment of the present disclosure, the restored original image, can be taken out from the bases image, the first image component information, and the second image component information, which are input into the decoding apparatus, by simple calculations.

(12) In the decoding apparatus according to the embodiment of the present disclosure, the image output from the output unit may have a vertical resolution of 2160.

(13) According to an embodiment of the present disclosure, there is provided a decoding apparatus including an input unit, a first down-conversion unit, a second down-conversion unit, a restoration unit, and an output unit. The input unit is configured to input a base image obtained by down-converting an original image at a predetermined first magnification, first image component information used to down-convert the original image at a predetermined second magnification that is different from the first magnification, the first image component information being part of information used to restore the original image from the base image, and second image component information used to down-convert the original image at a predetermined third magnification that is different from the first magnification and the second magnification, the second image component information being used together with the first image component information to restore the original image from the base image. The first down-conversion unit is configured to generate a first down-converted image corresponding to the original image down-converted at the second magnification by using the input first image component information. The second down-conversion unit is configured to generate a second down-converted image corresponding to the original image down-converted at the third magnification by using the input base image and the input second image component information. The restoration unit is configured to restore the original image by using the input base image, the input first image component information, and the input second image component information. The output unit is configured to output the input base image, the first down-converted image, the second down-converted image, and the restored original image.

In the embodiment of the present disclosure, the base image, the first down-converted image, the second down-converted image, and the restored original image can be taken out from the base image, the first image component information, and the second image component information, which are input into the decoding apparatus, by simple calculations.

(14) In the decoding apparatus according to the embodiment of the present disclosure, the base image output from the output unit may have a vertical resolution of 720, the first down-converted image may have a vertical resolution of 1080, the second down-converted image may have a vertical resolution of 1440, and the restored original image may have a vertical resolution of 2160.

(15) According to an embodiment of the present disclosure, there is provided an encoding method including: down-converting an input image at a predetermined first magnification to generate a base image; genera-ting first image component information, the first image component information being used to down-convert the input image at a predetermined second magnification that is different from the first magnification and being part of information used to restore the input image from the base image; and generating second image component information, the second image component information being used to down-convert the input image at a predetermined third magnification that is different from the first magnification and the second magnification and being used together with the first image component information to restore the input image from the base image.

(16) According to an embodiment of the present disclosure, there is provided a decoding method including: receiving a base image obtained by down-converting an original image at a predetermined first magnification, first image component information used to down-convert the original image at a predetermined second magnification that is different from the first magnification, the first image component information being part of information used to restore the original image from the base image, and second image component information used to down-convert the original image at a predetermined third magnification that is different from the first magnification and the second magnification, the second image component information being used together with, the first image component information to restore the original image from the base image, generating a down-converted image corresponding to the original image down-converted at the second magnification by using the first image component information; generating a down-converted image corresponding to the original image down-converted at the third magnification by using the base image and the second image component information; and restoring the original image by using the base image, the first image component information, and the second image component information.

As described above, according to the present disclosure, images with resolutions variously changed by simple calculations can be used.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a state where numbers D0 to D8 are assigned, to a 3×3 pixel group;

FIG. 2 is a diagram showing a state where numbers D10 to D48 are assigned to a 6×6 pixel group;

FIG. 3 is a diagram showing processing, through which an image input into an encoding apparatus is output from a decoding apparatus as output images with, respective resolutions;

FIG. 4 is a diagram showing how to use pixels of the input image for a 720P image as an output image;

FIG. 5 is a diagram showing how to use the pixels of the input image for a 1080P image as an output image;

FIG. 6 is a diagram showing how to use the pixels of the input image for a 1440P image as an output image;

FIG. 7 is a diagram showing a state where encoding processing and rearrangement processing are performed on the input image;

FIG. 8 is a diagram showing a specific example of a pixel rearrangement method;

FIG. 9 is a block diagram showing a configuration of an encoding apparatus;

FIG. 10 is a block diagram showing a configuration of a decoding apparatus;

FIG. 11 is a flowchart for describing the flow of the encoding processing in the encoding apparatus;

FIG. 12 is a flowchart for describing the flow of decoding processing for the 720P image, a 360P image, and a 180P image in the decoding apparatus;

FIG. 13 is a flowchart for describing the flow of decoding processing for the 1080P image, a 540P image, and a 270P image in the decoding apparatus;

FIG. 14 is a flowchart for describing the flow of decoding processing for the 1440P image in the decoding apparatus;

FIG. 15 is a flowchart for describing the flow of decoding processing for a 2160P image in the decoding apparatus;

FIG. 16 is a diagram showing processing, through which an image input into an encoding apparatus is output from a decoding apparatus as output images with respective resolutions;

FIG. 17 is a diagram showing how to use the pixels of the input image for the 1440P image as an output image;

FIG. 18 is a block diagram showing a configuration of the decoding apparatus; and

FIG. 19 is a diagram showing processing, through which an image input into an encoding apparatus is output from a decoding apparatus as output images with respective resolutions.

### DETAILED DESCRIPTION OF EMBODIMENTS

Hereinafter, three embodiments of the present disclosure will be described with reference to the drawings.

### First Embodiment

The present disclosure is roughly divided into two main features. One of the features is calculation by addition, subtraction, multiplication, and division between pixels to down-convert an image input into an encoding apparatus at a predetermined magnification. The other feature is decomposition of an input image into a base image and offset values from the base image to effectively compress data to be transmitted by coding offset value portions in order to effectively compress and transmit data from the encoding apparatus to a decoding apparatus.

In the following description, firstly, the calculation by addition, subtraction, multiplication, and division between pixels to down-convert an image input into the encoding apparatus at a predetermined magnification will be described. Then, calculations including the calculation of offset values will be described.

[Calculation for Down-Conversion (Outline)]

Firstly, the outline of the calculation by addition, subtraction, multiplication, and division between pixels to down-convert an image input into an encoding apparatus at a predetermined magnification will be described.

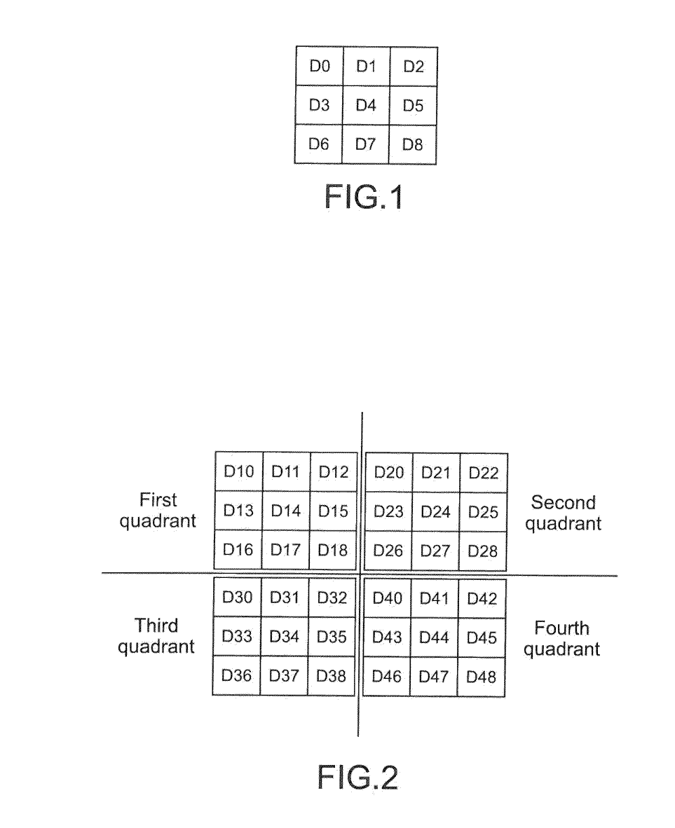

In the following description, in order to distinguish between the positions of pixels, an image is divided into 3×3 or 6×6 pixel groups, and description will be given with each pixel group as one unit. It should be noted that in the following description, as shown in FIG. 1, numbers of D0 to D8 are assigned to respective pixels in a 3×3 pixel group.

Further, as shown in FIG. 2, in a 6×6 pixel group, a 3×3 pixel group on the upper left is assumed to be pixels in a first quadrant, and numbers of D10 to D18 are assigned thereto. Similarly, a 3×3 pixel group on the upper right is assumed to be pixels in a second quadrant, and numbers of D20 to D28 are assigned thereto. Numbers are assigned to pixels in a third quadrant and a fourth quadrant in the same manner.

Further, in the following description, an image of 3840×2160P (Progressive) (horizontal resolution)×(vertical resolution) is referred to as a 2160P image. Similarly, images of 1920×1080P, 1280×720P, 950×540P, 640×360P, and 2560×1440P are referred to as a 1080P image, a 720P image, a 540P image, a 360P image, and a 1440P image, respectively.

Further, an image with a vertical resolution of 720×2ⁿ (n is an integer) is referred to as a 720-based image, and an image with a vertical resolution of 1080×2^{m} (m is an integer) is referred to as a 1080-based image.

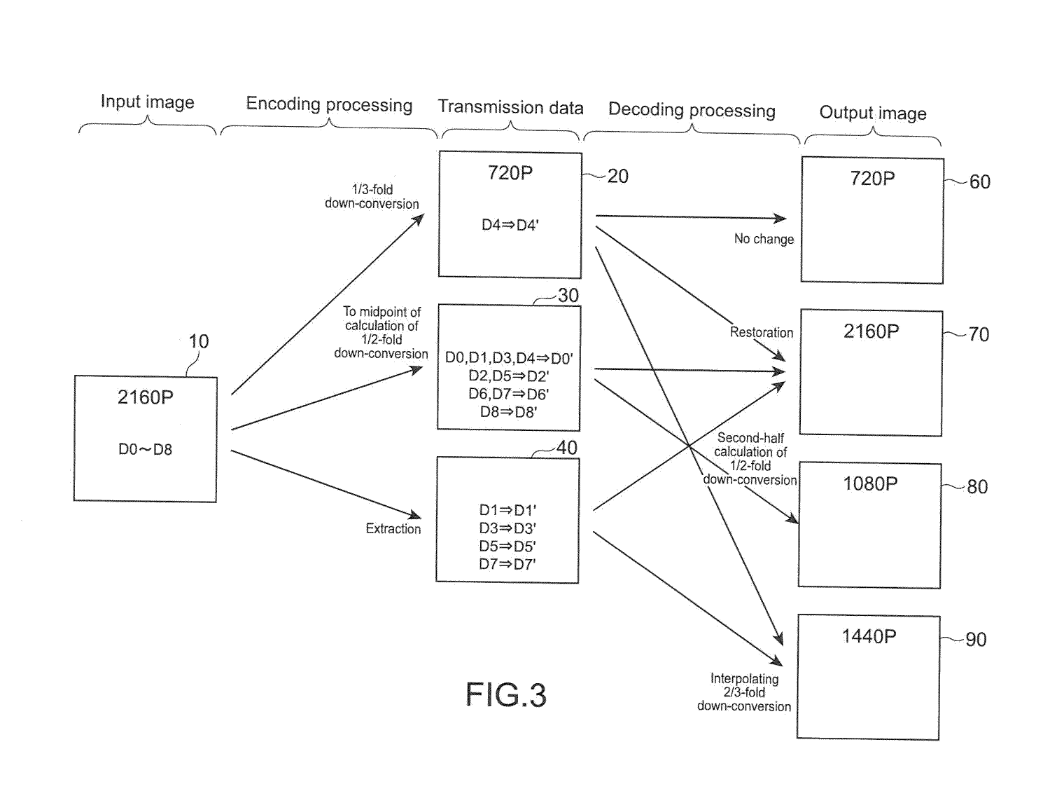

FIG. 3 is a diagram showing processing in this embodiment, through which an image input into an encoding apparatus is output from a decoding apparatus as output images with respective resolutions.

The leftmost image is a 2160P image 10 as an input image. Arrow portions on the right-hand side of the 2160P image 10 represent arithmetic processing performed in the encoding apparatus. A 720P image 20, a first image component 30, and a second image component 40 on the right-hand side of the arrow portions represent data transmitted from the encoding apparatus to a decoding apparatus. Arrow portions on the right-hand side of the data represent arithmetic processing performed in the decoding apparatus. The rightmost images of a 720P image 60, a 2160P image 70, a 1080P image 80, and a 1440P image 90 are images directly output from the decoding apparatus. The expression “directly” is used here because 720-based images and 1080-based images with resolutions other than those shown in FIG. 3 and images with resolutions that are not applicable to those image groups can also be output by the decoding apparatus locally performing down-conversion or up-conversion.

Hereinafter, a process of the 2160P image 10 as the input image to become the 720P image 60, the 2160P image 70, the 1080P image 80, and the 1440P image 90 as output images will be described one by one.

(Generation Process of 720P Image)

Firstly, description will be given along a process from the 2160P image 10 as the input image to the 720P image 60 as the output, image.

The input image to be input into the encoding apparatus is the 2160P image 10. The pixels D0 to D8 are included in a 3×3 pixel group of the 2160P image 10.

The 720P image 20 included in data, transmitted from the encoding apparatus to the decoding apparatus is generated by performing ⅓-fold down-conversion on the 2160P image 10. In the case of the ⅓-fold down-conversion by thinning-out, the 720P image 20 is generated based on the pixel D4 of the 2160P image 10.

It should be noted that FIG. 3 shows that a pixel D4′ of the 720P image 20, which is generated by encoding processing, is generated based on the pixel D4. In the following description, pixels with prime marks are the same as ones without, prime marks in terms of positions thereof, but the pixel values of the pixels with prime marks have been subjected to various types of processing and have different meanings from the original pixel values.

In the case where the 720P image 20 is transmitted to the decoding apparatus and output without changes, the 720P image 20 becomes the 720P image 60.

(Generation Process of 1080P Image)

Next, description will be given along a process from the 2160P image 10 as the input image to the 1080P image 80 as the output image.

The input image to be input into the encoding apparatus is the 2160P image 10 as in the above case.

Calculation processing for generating the 1080P image 80 in the decoding apparatus by performing ½-fold down-conversion on the 2160P image 10 is performed to a midpoint of the calculation processing so that the first image component 30 is generated. In the case of the 3×3 pixel group located in the first quadrant, a pixel D0′ Is calculated from the pixels D0, D1, D3, and D4. Similarly, pixels D2′, D6′, and D8′ are calculated. It should be noted that FIG. 3 does not show the pixel numbers of the 6×6 pixel group but shows the pixel numbers of the 3×3 pixel group for convenience sake.

The calculated first image component 30 is transmitted to the decoding apparatus, and thereafter a second-half calculation of the ½-fold down-conversion is performed to generate the 1080P image 80. Eventually, the 1080P image 80 is generated and then output from the decoding apparatus.

(Generation Process of 1440P Image)

Next, description will be given along a process from the 2160P image 10 as the input image to the 1440P image 90 as the output image.

The Input image to be input into the encoding apparatus is the 2160P image 10 as in the above case.

The pixels D1, D3, D5, and D7 are extracted from the 2160P image 10 and assumed to be pixels D1′, D3′, D5′, and D7′ generated by the encoding processing, to generate a second image component. The second image component is transmitted to the decoding apparatus. In the decoding apparatus, interpolating ⅔-fold down-conversion is performed on the second image component together with the pixel D4′ of the 720P image 20, which has also been transmitted from the encoding apparatus. Then, the 1440P image 90 is generated and output.

Here, the 1440P image 90 is calculated by the down-conversion using the pixels D1′, D3′, D4′, D5′, and D7′, while pixel values at the positions of the pixels D0′, D2′, D6′, and D8′ are not used. Therefore, the down-conversion is performed to interpolate those pixels. For that reason, the 1440P image 90 is different from an image obtained after ⅔-fold down-conversion is performed on the 2160P image 10 and is considered as a dummy 1440P image.

(Restoration Process of 2160P Image)

Next, description will be given along a process from the 2160P image 10 as the input image to the 2160P image 70 as the output image.

The input image to be input into the encoding apparatus is the 2160P image 10 as in the above case. Further, the 720P image 20, the first image component 30, and the second image component 40 included in the data transmitted from the encoding apparatus to the decoding apparatus are the same as those described above.

In the decoding apparatus, simultaneous equations are solved by using the pixel values of the encoded pixels D0′ to D8′ included in the received 720P image 20, first image component 30, and second image component 40, and values of the pixels D0 to D8 of the input image are inversely calculated, to generate (restore) and output the 2160P image 70.

Hereinabove, the outline of the calculation, for down-conversion has been described.

[Calculation for Down-Conversion (Detail)]

The detail of the calculation by addition, subtraction, multiplication, and division between pixels to down-convert an image input into the encoding apparatus at a predetermined magnification will be described.

(Calculation of 720P Image)

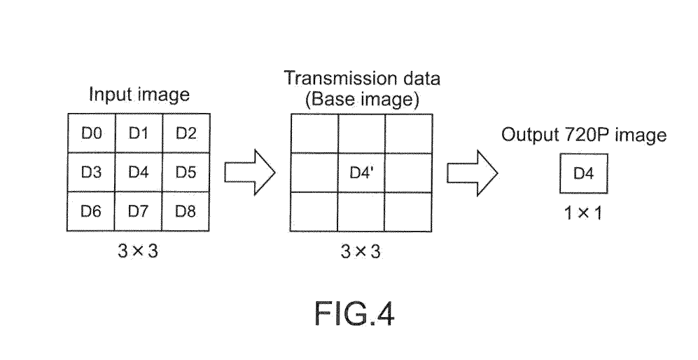

Firstly, description will be given on the generation of the 720P image 60. FIG. 4 is a diagram showing how to use the pixels of the input image for the 720P image as the output image.

On the left-hand side of FIG. 4, the array of 3×3 pixels of the input image is shown, and of those pixels, only the pixel D4 is subjected to the ⅓-fold down-conversion by thinning-out to be changed to a pixel D4′. Accordingly, a calculation expression for calculating the pixel D4′ is as follows.

D4′=D4 (1)

At the center of FIG. 4, the position of the pixel D4′ in the array of 3×3 pixels in the transmission data is shown. Then, the pixel D4′ in the transmission data transmitted to the decoding apparatus is extracted, by decoding processing to be changed to the 720P image 60 expressed by only 1×1 pixel D4. Here, it can be assumed that an inverse calculation of the following calculation expression is performed.

D4=D4′ (2)

The above is the generation method for the 720P image 60.

(Calculation of 1080P Image)

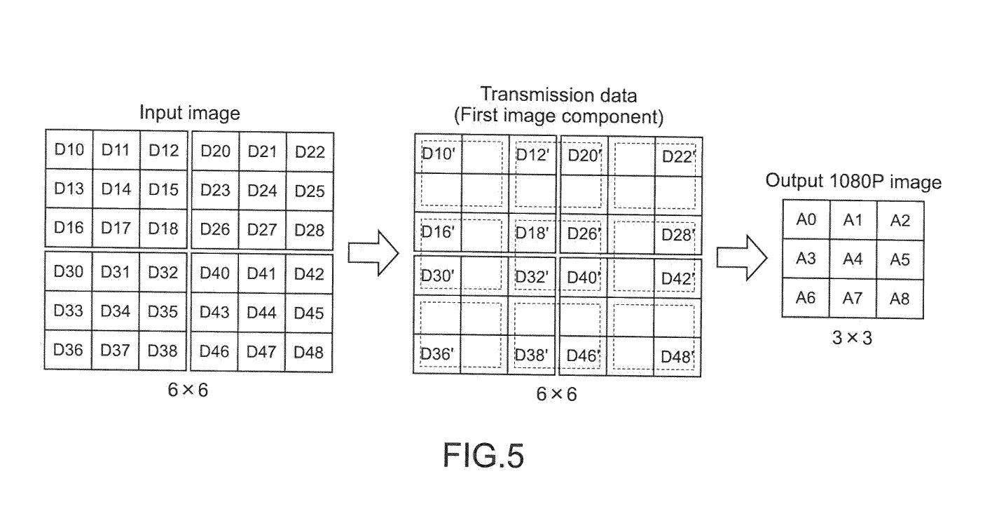

Next, description will be given on the generation of the 1080P image 80. FIG. 5 is a diagram showing how to use the pixels of the input image for the 1080P image as the output image according to the segmentation indicated by dotted lines.

On the left-hand side of FIG. 5, the array of 6×6 pixels of the input image is shown. By the following expressions, values of pixels D10′, D12′, D16′, D18′, D20′, D22′, D26′, D28′, D30′, D32′, D36′, D38′, D40′, D42′, D46′, and D48′ in the transmission data (first image component) shown at the center of FIG. 5 are obtained.

In the case of the first quadrant,

D10′=(D10+D11+D13+D14)/4 (3),

D12′=(D12+D15)12 (4),

D16′=(D16+D17)/2 (5), and

D18′=D18 (6).

In the case of the second quadrant,

D20′=(D20+D23)/2 (7),

D22′=(D21+D22+D24+D25)/4 (8),

D26′=D26 (9), and

D28′=(D27+D28)/2 (10),

In the case of the third quadrant,

D30′=(D30+D31)/2 (11),

D32′=D32 (12),

D36′=(D33+D34+D36+D37)/4 (13), and

D38′=(D35+D38)/2 (14),

In the case of the fourth quadrant,

D40′=D40 (15),

D42′=(D41+D42)/2 (16),

D46′=(D43+D46)/2 (17), and

D48′=(D44+D45+D47+D48)/4 (18).

As shown on the right-hand side of FIG. 5, the following calculations are further performed based on the first image component transmitted to the decoding apparatus so that values of pixels A0 to A8 are calculated. The pixels A0 to A8 form the 3×3 pixels of the 1080P image 80 as the output image.

A0=D10′ (19)

A1=(D12′+D20′)/2 (20)

A2=D22′ (21)

A3=(D16′+D30′)/2 (22)

A4=(D18′+D26′+D32′+D40′)/4 (23)

A5=(D28′+D42′)/2 (24)

A6=D36′ (25)

A7=(D38′+D46′)/2 (26)

A8=D48′ (27)

The above is the generation method for the 1080P image 80.

(Calculation of 1440P Image)

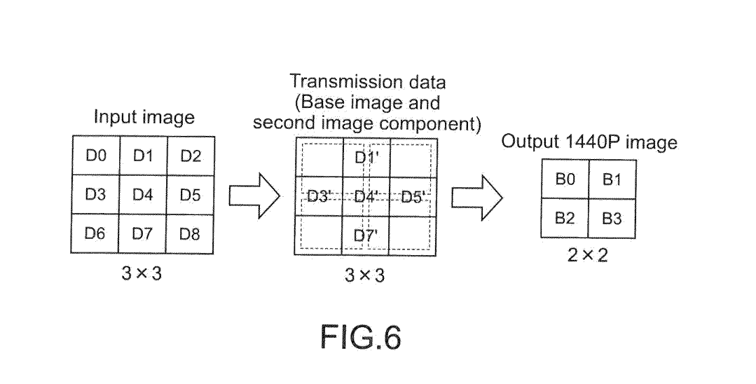

Next, description will be given on the generation of the 1440P image 90, FIG. 6 is a diagram showing how to use the pixels of the input image for the 1440P image as the output image according to the segmentation indicated by dotted lines.

On the left-hand side of FIG. 6, the array of 3×3 pixels of the input image is shown. By the following expressions, values of the pixels D1′, D3′, D4′, D5′, and D7′ in the transmission data (second image component) shown at the center of FIG. 6 are obtained.

D1′=D1 (28)

D3′=D3 (29)

D5′=D5 (30)

D7′=D7 (31)

It should be noted that the value of the pixel D4′ is obtained in the process of generating the 720P image 20 as in the expression (1) above. Therefore, the value of the pixel. D4′ is not calculated anew here.

As shown on the right-hand side of FIG. 6, the following calculations are further performed based on the second image component transmitted to the decoding apparatus so that values of pixels B0 to B3 are calculated. The pixels B0 to B3 form 2×2 pixels of the 1440P image as the output image.

B0=(D1′/2+D3′/2+D4′/4)×4/5 (32)

B1=(D1′/2+D5′/2+D4′/4)×4/5 (33)

B2=(D3′/2+D7′/2+D4′/4)×4/5 (34)

B3=(D5′/2+D7′/2+D4′/4)×4/5 (35)

The above is the generation method, for the 1440P image 90.

(Calculation of 2160P Image)

Next, description will be given on the restoration of the 2160P image 70. Calculations are performed similarly on the first quadrant to the fourth quadrant, and therefore calculations on only the first quadrant will be described here. It should be noted that the pixels D10′ to D18′ in the first quadrant of the 6×6 pixel group are the same as the pixels D0′ to D8′ of the 3×3 pixel group. Therefore, in the following description, expressions such as D10′=D0′ will be omitted.

Firstly, the value of the pixel D14 is obtained by the following expression based on the expression (2).

D14=D14′ (36)

Further, the values of the pixels D1, D3, D5, and D7 are obtained by the following expression based on the expressions (28) to (31).

D11=D11′ (37)

D13=D13′ (38)

D15=D15′ (39)

D17=D17′ (40)

Furthermore, since the calculations are made for the first quadrant now, the following expression is established based on the expression (6).

D18=D18′ (41)

The value of the pixel. D12 is obtained by the following expression based on the expression (4).

D12=2×D12′−D15 (42)

The value of the pixel D16 is obtained by the following expression based on the expression (5).

D16=2×D16′−D17 (43)

Then, the value of the pixel D10 is obtained by the following expression based on the expression (3).

D10=4×D10′−(D11+D13+D14) (44).

By the above calculations, the values of the nine pixels in the first quadrant are obtained. After the values of the pixels in the second quadrant to the fourth quadrant are obtained in the same manner, the 2160P image 70 can be restored.

[Calculation of Offset Value]

In the present disclosure, in addition to the computations between pixels for the down-conversion described above, coding is performed on the first image component and the second image component in order to efficiently compress the transmission data when the transmission data is transmitted from the encoding apparatus to the decoding apparatus.

Coding is not directly performed on those image components but performed on offset values in order to increase a compression ratio. The offset values are obtained between the 720P image 20 to be a base image and each of the first image component and the second image component. Huffman coding or arithmetic coding can be used for the coding.

Specifically, in the 3×3 pixel group, differences between the pixel D4′ of the base image and each of the pixels D0′, D2′, D6′, and D8′ of the first image component and between the pixel D4′ of the base image and the pixels D1′, D3′, D5′, and B7′ of the second image component are obtained.

Since many offset values are zero in a low-frequency region of the image, the compression ratio in the coding can be increased and thus an efficient compression can be performed. Therefore, the transmission data output from the encoding apparatus can be transmitted as a single LLVC (Low Latency Video Codec) stream to the decoding apparatus in a bandwidth of 10 Gbps. In the single LLVC stream, images with a plurality of resolutions are collected

In other words, if two types of coherent signal components are negatively combined, highly correlated portions are weaken with each other to be zero, which allows the compression by coding to be efficiently performed.

It should be noted that the calculation of offset, values has an advantage in addition to an increase in the compression ratio of the coding. For example, in the case where processing of uniformly adjusting the image quality for all pixels, such as white balance processing, is performed, the processing only needs to be performed on only the pixels of the base image in the embodiments of present disclosure, instead of performing computations on all pixels of the 2160P image as the input image. Since the base image is a reference image for obtaining the offset values, if white balance and the like of this reference image are changed, the effect to be obtained when the processing is performed on images with all resolutions can be obtained.

Hereinafter, description will be given on how actual calculation expressions are changed when the calculations of offset values are included in the calculation expressions between pixels for down-conversion described above.

(Calculation of 720P Image)

Firstly, since the 720P image 20 is the base image, calculations of offset values are not performed for the 720P image 20. The pixel value D4′ of the base image is used in the following calculations.

In the case where the 6×6 pixel group is used when the 1080P image and the 2160P image are generated, the pixel D4′ of the base image is the pixel D14′ in the first quadrant as described above.

(Calculation of 1080P Image)

Next, calculation expressions used when the 1080P image 80 is generated are shown as follows. In the case of the first quadrant, the first image component is calculated as follows. The same holds true for the second quadrant and the other quadrants and description thereof will be omitted.

D10′=(D10+D11+D13+D14)/4−D14′ (45)

D12′=(D12+D15)/2−D14′ (46)

D16′=(D16+D17)/2−D14′ (47)

D18′=D18−D14′ (48)

Then, the values of the pixels A0 to A8 that form the 3×3 pixels of the 1080P image 80 as the output image are as follows.

A0=D10′+D14′ (49)

A1=(D12′+D20′)/2+D14′ (50)

A2=D22′+D14′ (51)

A3=(D16′+D30′)/2+D14′ (52)

A4=(D18′+D26′+D32′+D40′)/4+D14′ (53)

A5=(D28′+D42′)/2+D14′ (54)

A6=D36′+D14′ (55)

A7=(D38′+D46′)/2+D14′ (56)

A8=D48′+D14′ (57)

The above is the calculation method for the 1080P image 80.

(Calculation of 1440P Image)

Next, calculation expressions used when the 1440P image 90 is generated are shown as follows. Firstly, the second image component is calculated as follows,

D1′=D1−D4′ (58)

D3′=D3−D4′ (59)

D5′=D5−D4′ (60)

D7′=D7−D4′ (61)

Then, the values of the pixels B0 to B3 that form the 2×2 pixels of the 1440P image 90 as the output image are as follows.

B0=(D1′/2+D3′/2+D4′×5/4)×4/5 (62)

B1=(D1′/2+D5′/2+D4′×5/4)×4/5 (63)

B2=(D3′/2+D7′/2+D4′×5/4)×4/5 (64)

B3=(D5′/2+D7′/2+D4′×5/4)×4/5 (65)

The above is the calculation method for the 1440P image 90.

(Calculation of 2160P Image)

Next, calculation expressions used when the 2160P image 70 is restored are shown. The calculation expressions are as follows. It should be noted that only the first quadrant will be described here.

Firstly, the value of the pixel D14 is obtained by the following expression based on the expression (2).

D14−D14′ (66)

Further, the values of the pixels D1, D3, D5, and D7 are obtained by the expressions (58) to (61),

D11=D11′+D14′ (67)

D13=D13′+D14′ (68)

D15=D15′+D14′ (69)

D17−D17′+D14′ (70)

Furthermore, since the calculations are made for the first, quadrant now, the following expression is established based on the expression (48).

D18=D18′+D14′ (71)

The value of the pixel D12 is obtained by the following expression based on the expression (46).

D12=2×(D12′+D14′)−D15 (72)

The value of the pixel D16 is obtained by the following expression based on the expression (47).

D16=2×(D16′+D14′)−D17 (73)

Then, the value of the pixel D10 is obtained by the following expression based on the expression (45).

D10=4×(D10′+D14′)−(D11+D13+D14) (74)

The above is the calculation method for the 2160P image 70.

[Rearrangement of Pixels of Transmission Data]

In the embodiments of the present disclosure, in order that the decoding apparatus may easily extract the 720P image 20 included in the transmission data transmitted from the encoding apparatus and also in order to facilitate calculations when the encoding processing is multiply performed, the pixels are rearranged when the transmission data is generated.

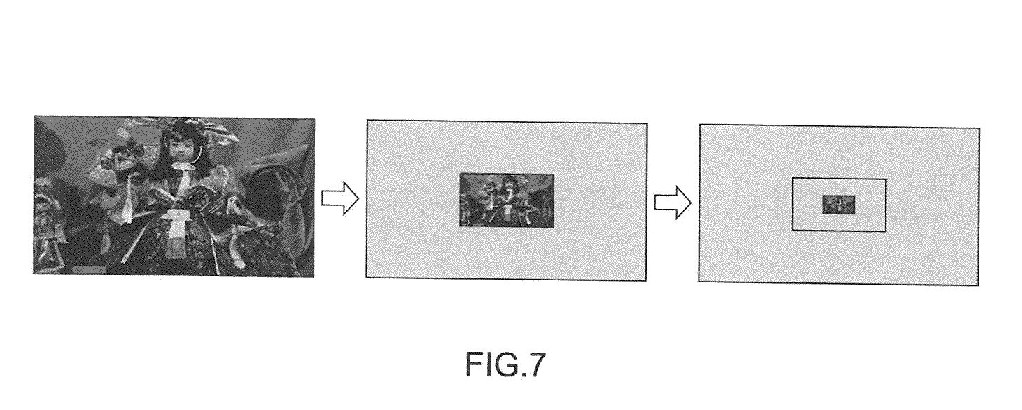

FIG. 7 is a diagram showing a state where the encoding processing and rearrangement processing are performed on the input image. The image on the left-hand side of FIG. 7 is the input image. The center of the FIG. 7 shows a state where after performing the encoding processing once, rearrangement is performed such that the 720P image is positioned at the center of the transmission data. The image on the right-hand side of FIG. 7 shows a state after the encoding processing and the rearrangement processing are performed again. It is found that instead of the 720P image, the first and second image components generated by performing the encoding processing again and a 240P image are included at the center of the transmission data.

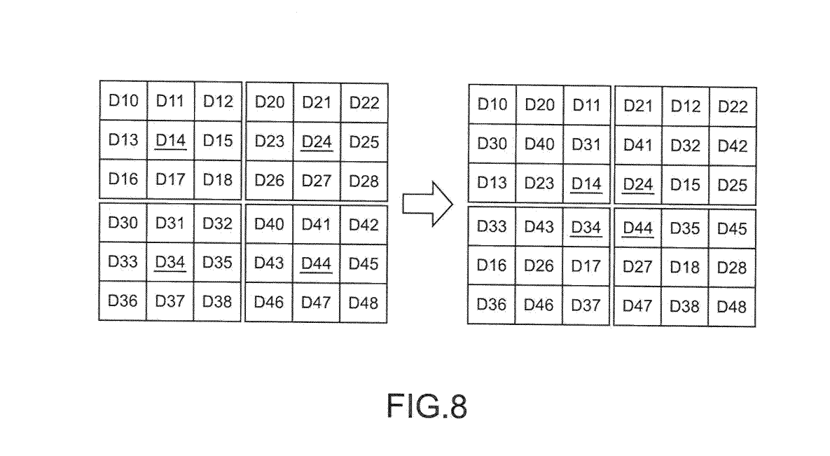

FIG. 8 is a diagram showing a specific example of a pixel rearrangement method. The pixel D14 at the center of the 3×3 pixel group in the first quadrant and pixels D24, D34, and D44 located in the other quadrants are pixels that form the 720P image 20 as the base image. In FIG. 8, those pixels are underlined. Those pixels are collected to the center of the transmission data, which is shown on the right-hand side of FIG. 8. It is found that the underlined pixels D14, D24, D34, and D44 are collected to the center of the transmission data.

Hereinabove, the rearrangement of the 720P image 20 as the base image in the transmission data has been described.

[Configuration of Encoding Apparatus]

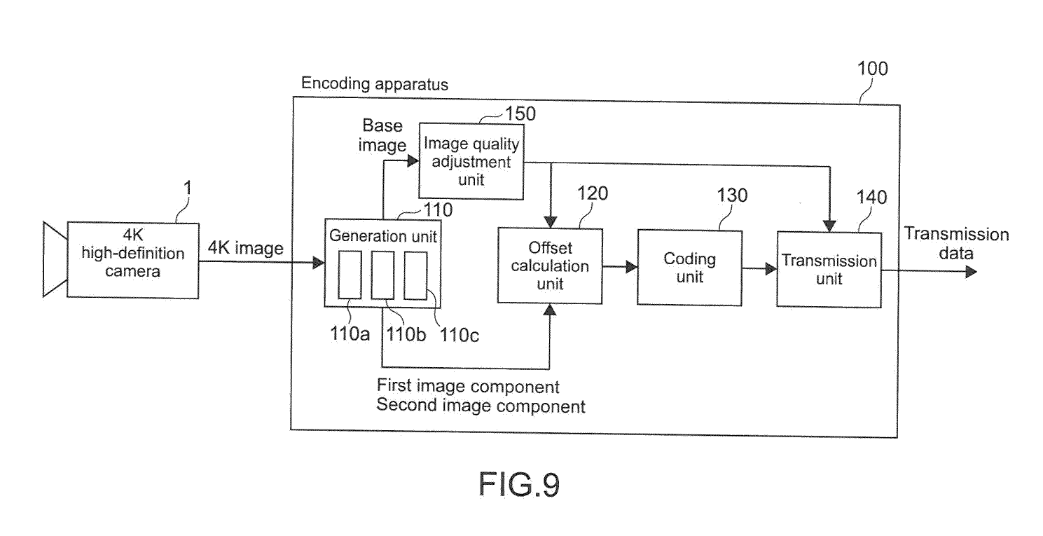

Next, a configuration of the encoding apparatus will be described. FIG. 9 is a block diagram showing a configuration of an encoding apparatus 100.

The encoding apparatus 100 includes a generation unit 110, an offset, calculation unit 120, a coding unit 130, a transmission unit 140 (output unit), and an image quality adjustment unit 150. It should be noted that the generation unit 110 is configured to include a base image generation unit 110a, a first image component generation unit 110b, and a second image component generation unit 110c.

For example, the encoding apparatus 100 is connected to a 4K high-definition camera 1. A 4K high-definition image is input from the connected 4K high-definition camera 1.

The 4K high-definition image input into the encoding apparatus 100 is passed, to the generation unit 110.

The generation unit 110 performs the ⅓-fold down-conversion on the 4K high-definition image (2160P image 10) to generate a base image (720P image 20) as described above. The generated base image is passed to the image quality adjustment unit 150.

Further, the generation unit 110 performs the ½-fold down-conversion on the 4K high-definition image (2160P image 10) to a midpoint of the processing to generate the first image component and also extracts some pixels to generate the second, image component as described above. The generated first and second image components are passed, to the offset calculation unit 120.

The image quality adjustment unit 150 performs processing of uniformly adjusting the image quality over the entire image, such as white balance processing, on the base image passed from the generation unit 110. The base image whose image quality has been adjusted is passed to the offset calculation unit 120 and the transmission unit 140.

The offset calculation unit 120 calculates offset values of the first and second image components passed from the generation unit 110 with respect to the base image passed from the image quality adjustment unit 150 as described above. The calculated offset values of the first and second image components are passed to the coding unit 130.

The coding unit 130 codes the offset values of the first and second image components passed from the offset calculation unit 120. Huffman coding, arithmetic coding, and the like may be used for the coding as described above. The coded offset values of the first and second image components are passed to the transmission unit 140.

The transmission unit 140 transmits the base image passed from the generation, unit 110 and the offset values of the first, and second image components passed from the coding unit 130, as transmission data, to the decoding apparatus.

Although it has been described above that the encoding apparatus 100 includes the generation unit 110, the offset calculation unit 120, the coding unit 130, and the transmission unit 140, the encoding apparatus 100 may be configured to include only the generation unit 110 and the transmission unit 140 in the case where the transmission data is transmitted without being compressed.

Hereinabove, the configuration, of the encoding apparatus 100 has been described.

[Configuration of Decoding Apparatus]

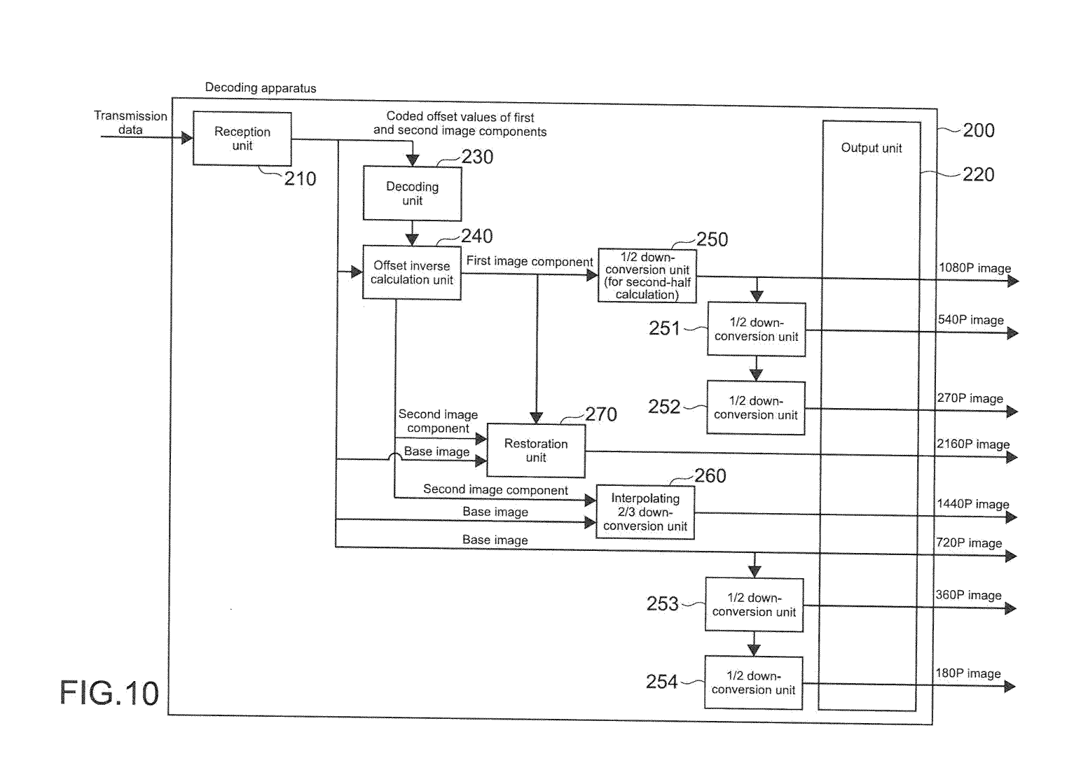

Next, a configuration of the decoding apparatus will be described. FIG. 10 is a block diagram showing a configuration of a decoding apparatus 200.

The decoding apparatus 200 includes a reception unit 210 (input unit), an output unit 220, a decoding unit 230, an offset inverse calculation unit 240, a ½ down-conversion unit (for second-half calculation) 250 (down-conversion unit, first down-conversion unit), ½ down-conversion units 251, 252, 253, and 254, an interpolating ⅔ down-conversion unit 260 (down-conversion unit, second down-conversion unit), and a restoration unit 270.

In the above configuration, a 2160P image, a 1440P image, a 1080P image, a 720P Image, a 540P image, a 270P image, a 360P image, and a 180P image can be output from the decoding apparatus 200.

It should be noted that the ½ down-conversion units 251, 252, 253, and 254 are not indispensable constituent elements and may be provided only in the cases where the 540P image, the 270P image, the 360P image, and the 180P image are output from the decoding apparatus 200.

Further, for example, in the case where a 135P image obtained by further performing the ½-fold down-conversion on the 270P image is output, another ½ down-conversion unit to perform one more down-conversion stage may be provided at a subsequent stage of the ½ down-conversion unit 252.

Furthermore, although the plurality of ½ down-conversion units are prepared in the above description, only one ½ down-conversion unit to perform the ½-fold down-conversion processing may be provided so that the ½-fold down-conversion processing may be performed a plurality of times by returning the output of the ½ down-conversion unit to the input thereof.

As described above, the configuration of the decoding apparatus 200 is variously modified due to an increase and decrease in types of resolutions of output images.

For example, in the case where only the 720P image is obtained as the output image, the indispensable constituent elements are only the reception unit 210 and the output unit 220. For example, in the case where the 360P image is obtained as the output image, the ½ down-conversion unit 253 is added to the configuration so that the 720P image is subjected to the ½-fold down-conversion.

In the case where only the 1080P image is obtained as the output image, the indispensable constituent elements are only the reception unit 210, the decoding unit 230, the offset inverse calculation unit 240, the ½ down-conversion unit (for second-half calculation) 250, and the output unit 220. For example, in the case where the 540P image is obtained as the output image, the ½ down-conversion unit 251 is added to the configuration so that the 1080P image is subjected to the ½-fold down-conversion.

In the case where only the 1440P image is obtained as the output image, the indispensable constituent elements are only the reception unit 210, the decoding unit 230, the offset, inverse calculation unit 240, the interpolating ⅔ down-conversion unit 260, and the output unit 220.

In the case where only the 2160P image is obtained as the output image, the indispensable constituent elements are only the reception unit 210, the decoding unit 230, the offset inverse calculation unit 240, the restoration unit 270, and the output unit 220.

Hereinafter, the blocks of the decoding apparatus 200 will be described.

The reception unit 210 receives the base image and the coded offset values of the first and second image components, which are transmitted from the encoding apparatus 100. The reception unit 210 passes the received base image to the output unit 220, the offset inverse calculation unit 240, the interpolating ⅔ down-conversion unit 260, and the restoration unit 270.

Further, the received, coded offset values of the first and second image components are passed to the decoding unit 230.

The output unit 220 outputs the 720P image, the 1080P image, the 1440P image, and the 2160P image to the outside, which are passed from the reception unit 210, the ½ down-conversion unit, (for second-half calculation) 250, the interpolating ⅔ down-conversion unit 260, and the restoration unit 270, respectively. In the case where the ½ down-conversion units 251 and 252 are provided, the output unit 220 outputs the 540P image and the 270P image to the outside.

The decoding unit 230 decodes the coded offset values of the first and second image components passed from the reception unit 210. Decoding is performed by an inverse computation of the coding that has been performed in the coding unit 130 of the encoding apparatus 100. The decoded offset values of the first and second image components are passed to the offset inverse calculation unit 240.

The offset inverse calculation unit 240 returns the offset values to the original values before the offset values are calculated, based on the pixel values of the base image passed, from the reception unit 210 and the offset values of the first and second image components passed from the decoding unit 230, to calculate the first and second image components. The offset inverse calculation unit 240 passes the calculated first image component to the ½ down-conversion unit (for second-half calculation) 250 and the restoration unit 270. Further, the offset inverse calculation unit 240 passes the calculated second image component to the interpolating ⅔ down-conversion unit 260 and, the restoration unit 270.

The ½ down-conversion unit (for second-half calculation) 250 receives the first image component from the offset inverse calculation unit 240. Then, as described above, based on the first image component, the ½ down-conversion unit (for second-half calculation) 250 performs the remaining calculation to generate the 1080P image. The first image component has been obtained by the calculation for generating the 1080P image by performing the ½-fold down-conversion on the 2160P image to a midpoint of the calculation. The ½ down-conversion unit (for second-half calculation) 250 passes the generated 1080P image to the output unit 220. Further, in the case where the 540P Image and the 270P image are obtained, the ½ down-conversion unit (for second-half calculation) 250 passes the generated 1080P image to the ½ down-conversion unit 251.

It should be noted that the ½ down-conversion units 251, 252, 253, and 254 are each configured to perform the ½-fold down-conversion processing on the input image and output the resultant image.

The interpolating ⅔ down-conversion unit 260 uses the base image passed from the reception unit 210 and the second image component passed from the offset inverse calculation unit 240 to perform a ⅔-fold down-conversion calculation while performing interpolation, to generate the 1440P image as described above. The interpolating ⅔ down-conversion unit 260 passes the generated 1440P image to the output unit 220.

The restoration unit 270 uses the base image passed from the reception unit 210 and the first and second image components passed from the offset inverse calculation unit 240 to restore the 2160P image as described above. The restoration unit 270 passes the restored 2160P image to the output unit 220.

Hereinabove, the configuration of the decoding apparatus 200 has been described.

[Flow of Encoding Processing]

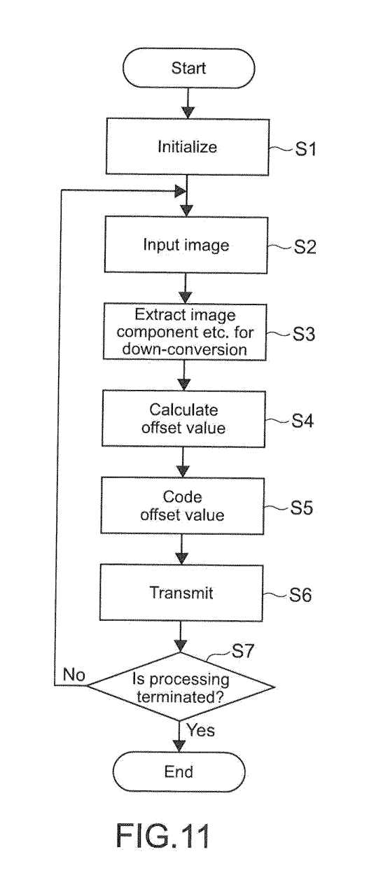

Next, the flow of the encoding processing for the input image in the encoding apparatus 100 will be described. FIG. 11 is a flowchart for describing the flow of the encoding processing in the encoding apparatus 100.

Firstly, the encoding apparatus 100 initializes the Individual units before starting the encoding processing (Step S1).

Next, the generation unit 110 receives an input of an image from the outside (Step S2).

Next, the generation unit 110 extracts the base image, the first image component, and the second image component from the input image (Step S3). An extraction method is as described above.

Next, the offset calculation unit 120 calculates offset values of the first and second image components from the pixel values of the base image (Step S4).

Next, the coding unit 130 codes the offset values calculated in Step S4 (Step S5).

Next, the transmission unit 140 transmits the base image extracted in Step S3 and the offset values of the first and second image components that are coded in Step S5 to the decoding apparatus 200 (Step S6).

Lastly, the encoding apparatus 100 determines whether the encoding processing is terminated or not (Step S7). In the case where the encoding processing is not terminated (No in Step S7), the processing returns to Step S2 and an input of the next image is received to continue the encoding processing.

Hereinabove, the flow of the encoding processing in the encoding apparatus 100 has been described.

[Flow of Decoding Processing]

Next, the flow of the decoding processing for the received image in the decoding apparatus 200 will be described.

(720P Image, 360P Image, and 180P Image)

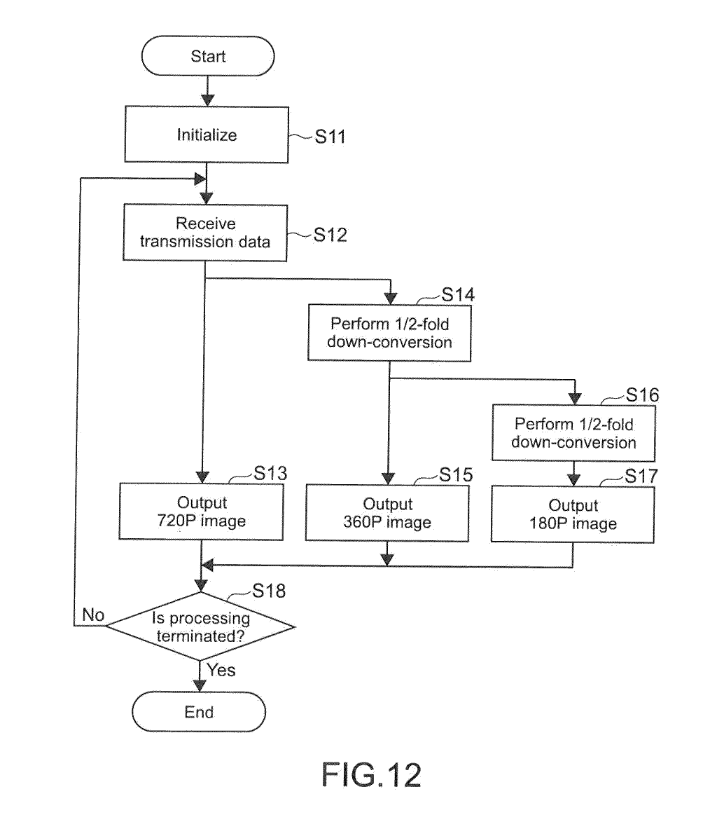

FIG. 12 is a flowchart for describing the flow of the decoding processing for the 720P image, the 360P image, and the 180P image in the decoding apparatus 200.

Firstly, the decoding apparatus 200 initializes the individual units before starting the decoding processing (Step S11).

Next, the reception unit 210 receives the transmission data, that is, the base image and the coded offset values of the first and second image components (Step S12).

As to the 720P image, after Step S12, the output unit 220 outputs the received base image (720P image) to the outside (Step S13).

As to the 360P image, after Step S12, the ½ down-conversion unit 253 performs the ½-fold down-conversion processing on the received base image (Step S14). Then, the output unit 220 outputs the down-converted 360P image to the outside (Step S15).

As to the 180P image, after Step S14, the ½ down-conversion, unit 254 further performs the ½-fold down-conversion processing on the image that has been subjected to the ½-fold down-conversion processing (Step S16). Then, the output unit 220 outputs the down-converted 180P image to the outside (Step S17).

After the images obtained in Steps S13, S15, and S17 are output to the outside, the decoding apparatus 200 determines whether the decoding processing is terminated or not (Step S18). In the case where the decoding processing is not terminated (No in Step S18), the processing returns to Step S12 and an input of the next image is received to continue the decoding processing.

Hereinabove, the flow of the decoding processing for the 720P image, the 360P image, and the 180P image in the decoding apparatus 200 has been described.

(1080P Image, 540P Image, and 270P Image)

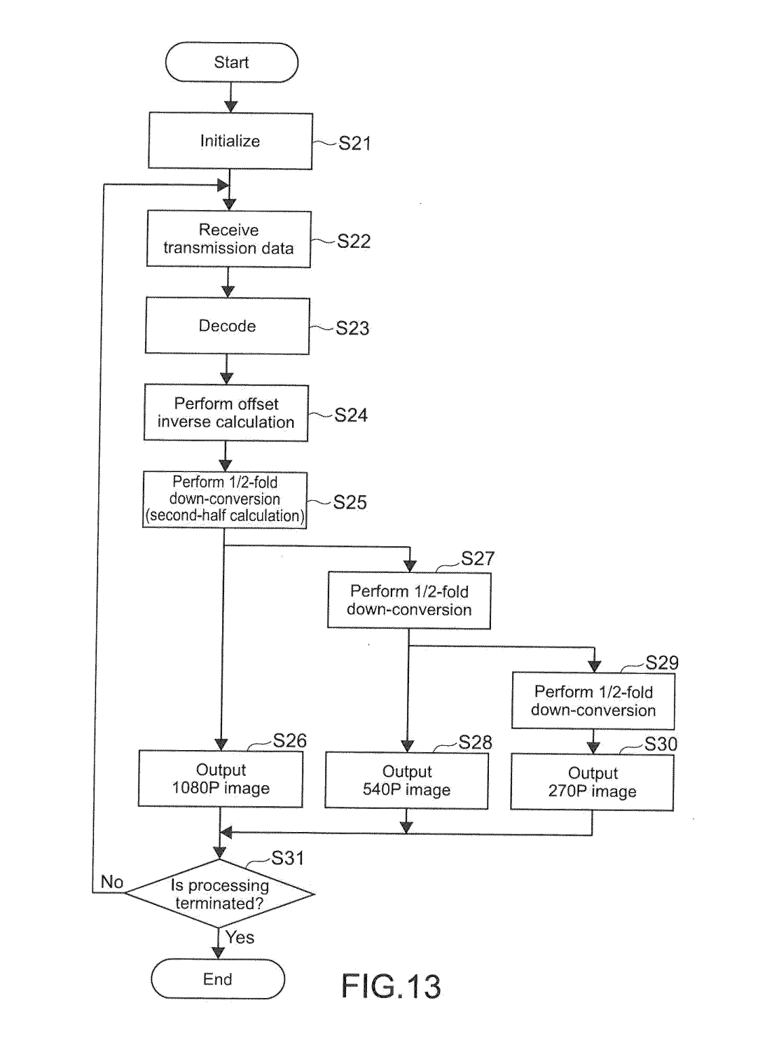

FIG. 13 is a flowchart for describing the flow of the decoding processing for the 1080P image, the 540P image, and the 270P image in the decoding apparatus 200.

Firstly, the decoding apparatus 200 initializes the individual units before starting the decoding processing (Step S21).

Next, the reception unit 210 receives the transmission data, that is, the base image and the coded offset values of the first and second image components (Step S22).

Next, the decoding unit 230 decodes the coded offset-value of the first image component (Step S23).

Next, the offset inverse calculation unit 240 returns the offset value of the first image component to the original value before the offset value is calculated, based on the decoded offset value of the first image component and the base image received, by the reception unit 210 (Step S24).

Next, the ½ down-conversion unit (for second-half calculation) 250 performs a second-half calculation of the ½-fold down-conversion by using the first image component to generate the 1080P image (Step S25).

As to the 1080P image, after Step S25, the output unit 220 outputs the generated 1080P image to the outside (Step S26).

As to the 540P image, after Step S25, the ½ down-conversion unit 251 performs the ½-fold down-conversion processing on the generated 1080P image (Step S27). Then, the output unit 220 outputs the down-converted 540P image to the outside (Step S28).

As to the 270P image, after Step S27, the ½ down-conversion unit 252 further performs the ½-fold down-conversion processing on the image that has been subjected to the ½-fold down-conversion processing (Step S29). Then, the output unit 220 outputs the down-converted 270P image to the outside (Step S30).

After the images obtained in Steps S26, S28, and S30 are output to the outside, the decoding apparatus 200 determines whether the decoding processing is terminated or not (Step S31). In the case where the decoding processing is not terminated (No in Step S31), the processing returns to Step S22 and an input of the next image is received to continue the decoding processing.

Hereinabove, the flow of the decoding processing for the 1080P image, the 540P image, and the 270P image in the decoding apparatus 200 has been described.

(1440P Image)

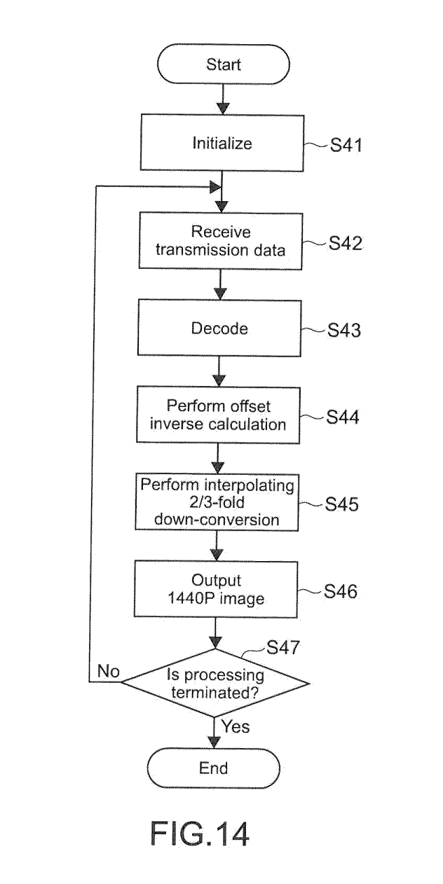

FIG. 14 is a flowchart for describing the flow of the decoding processing for the 1440P image in the decoding apparatus 200.

Firstly, the decoding apparatus 200 initializes the individual units before starting the decoding processing (Step S41).

Next, the reception unit 210 receives the transmission data, that is, the base image and the coded offset values of the first and second image components (Step S42).

Next, the decoding unit 230 decodes the coded offset value of the second image component (Step S43).

Next, the offset inverse calculation unit 240 returns the offset value of the second image component to the original, value before the offset value is calculated, based on the decoded offset, value of the second image component and the base image received by the reception unit 210 (Step S44).

Next, the interpolating ⅔ down-conversion unit 260 uses the base image and the second image component to perform the ⅔-fold down-conversion calculation while performing interpolation, to generate the 1440P image (Step S45).

Next, the output unit 220 outputs the generated 1440P image to the outside (Step S46).

Next, the decoding apparatus 200 determines whether the decoding processing is terminated or not (Step S47). In the case where the decoding processing is not terminated (No in Step S47), the processing returns to Step S42 and an input of the next image is received to continue the decoding processing.

Hereinabove, the flow of the decoding processing for the 1440P image in the decoding apparatus 200 has been described.

(2160P Image)

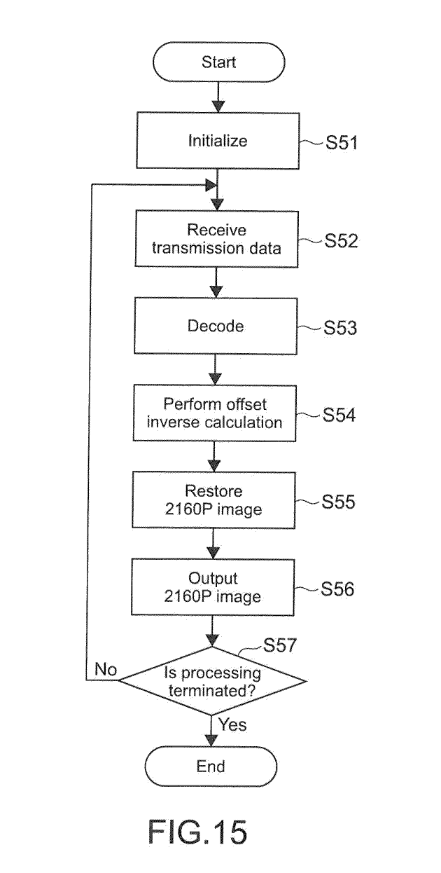

FIG. 15 is a flowchart for describing the flow of the decoding processing for the 2160P image in the decoding apparatus 200.

Firstly, the decoding apparatus 200 initializes the individual units before starting the decoding processing (Step S51).

Next, the reception unit 210 receives the transmission data, that is, the base image and the coded offset values of the first and second image components (Step S52).

Next, the decoding unit 230 decodes the coded offset values of the first and second image components (Step S53).

Next, the offset inverse calculation unit 240 returns the offset values of the first and second image components to the original values before the offset values are calculated, based on the decoded offset values of the first and second image components and the base image received by the reception unit 210 (Step S54).

Next, the restoration unit 270 uses the base image and the first and second image components to solve the simultaneous equations, to restore the 2160P image (Step S55).

Next, the output unit 220 outputs the restored 2160P image to the outside (Step S56).

Next, the decoding apparatus 200 determines whether the decoding processing is terminated or not (Step S57). In the case where the decoding processing is not terminated (No in Step S57), the processing returns to Step S52 and an input of the next image is received to continue the decoding processing.

Hereinabove, the flow of the decoding processing for the 2160P image in the decoding apparatus 200 has been described.

Up to here, the first embodiment of the present disclosure has been described.

### Second Embodiment

Next, a second embodiment of the present disclosure will be described. It should be noted that in the following description, only a difference from the first embodiment will be described.

[Difference from First Embodiment (Outline)]

In the first embodiment, since only the pixels D1, D3, D4, D5, and D7 are used in order to obtain the 1440P image, portions corresponding to the pixels D0, D2, D6, and D8 are supplemented by interpolation when the ⅔-fold down-conversion is performed. Therefore, the generated 1440P image is a dummy 1440P image.

In the second embodiment, all pixel values of the pixels D0 to D8 are used to obtain the 1440P image. Therefore, the generated 1440P image is an accurate ⅔-fold down-converted image. However, since the calculation method for the 1440P image is changed, another original pixel value has to be used to solve the simultaneous equations when the 2160P image is restored. In the following description, as an example, a pixel value of the pixel D5 is assumed to be included in the transmission data, but any pixel may be used as long as it is not the pixel D4,

[Calculation for Down-Conversion (Outline)]

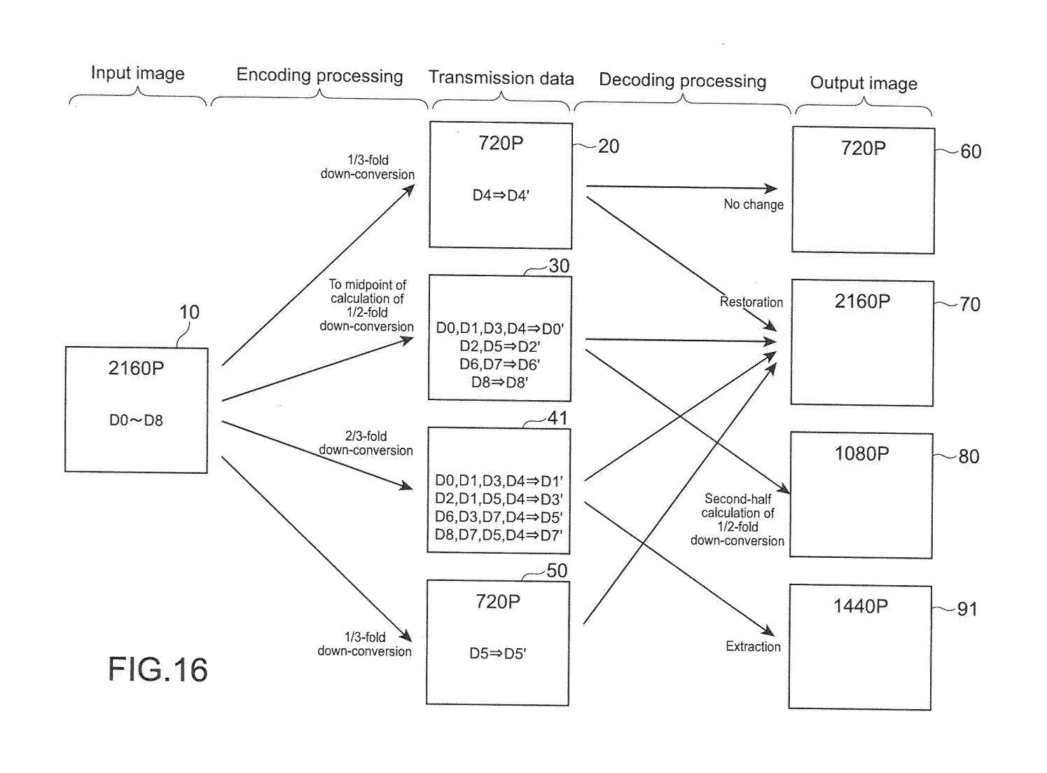

FIG. 16 is a diagram showing processing in this embodiment, through which an image input into an encoding apparatus 101 is output, from a decoding apparatus 201 as output images with respective resolutions.

The difference from the first embodiment is a generation process of the 1440P image and a restoration process of the 2160P image. The processes on the 720P image and the 1080P image are the same as those described in the first embodiment and therefore description thereof will be omitted.

(Generation Process of 1440P Image)

Firstly, description will be given along a process from the 2160P image 10 as the input image to a 1440P image 91 as the output image.

The input image to be input into the encoding apparatus 101 is the 2160P image 10. The pixels D0 to D8 are included in a 3×3 pixel group of the 2160P image 10.

In this embodiment, arithmetic processing of ⅔-fold down-conversion is performed by the encoding-apparatus 101. Specifically, a value of a pixel B0 of a down-converted 2×2 pixel group is calculated based on the pixels D0, D1, D3, and D4, for example. However, the value of the pixel B0 is arranged at a position of the pixel B0 in the down-converted 2×2 pixel array by the decoding apparatus 201. Therefore, in transmission data, the calculated value of the pixel B0 is arranged at a pixel position of the pixel D1′ of the original 3×3 pixel group and then transmitted.

In such a manner, the values of the pixels B0 to B3 of the down-converted 2×2 pixel group obtained by the ⅔-fold down-conversion arithmetic processing are stored at the positions of the pixels D1′, D3′, D5′, and D7′ of the original 3×3 pixel group and then transmitted. Then, in the decoding apparatus 201, the values are rearranged to appropriate pixel, positions of the 2×2 pixel group to generate the 1440P image,

(Restoration Process of 2160P Image)

Next, description will be given along a process from the 2160P image 10 as the input image to the 2160P image 70 as the output image.

The input image to be input into the encoding apparatus is the 2160P image 10 as in the above case. Further, the 720P image 20 and the first image component included in the data transmitted from the encoding apparatus to the decoding apparatus are the same as those described in the first embodiment.

A second image component 41 is an image component obtained by performing the ⅔-fold down-conversion on the 2160P image 10 as described in the generation process of the 1440P image.

As described above, a third image component 50 is obtained by collecting the pixels D5 in the 3×3 pixel groups, for example. The pixels D5 are extracted by performing the ⅓-fold down-conversion processing by thinning-out on the 2160P image 10 as the input image.

In such a manner, in the second embodiment, the third image component is also transmitted as the transmission data to the decoding apparatus 201, in addition to the base image (720P image 20) and the first and second image components.

In the decoding apparatus 201, simultaneous equations are solved by using the pixel values of the encoded pixels D0′ to D8′ Included in the received 720P image 20, first image component 30, and second image component 41 and the pixel value of the pixel D5′ included in the received third image component 50, and the values of the pixels D0 to D8 of the input image are inversely calculated, to generate (restore) and output the 2160P image 70.

Hereinabove, the outline of the calculation for down-conversion has been described,

[Calculation for Down-Conversion (Detail)]

The detail of the calculation by addition, subtraction, multiplication, and division between pixels in order to down-convert an image input into the encoding apparatus 101 at a predetermined magnification will be described. It should be noted that the 720P image and the 1080P image are the same as those in the first embodiment and therefore description thereof will be omitted.

(Calculation of 1440P image)

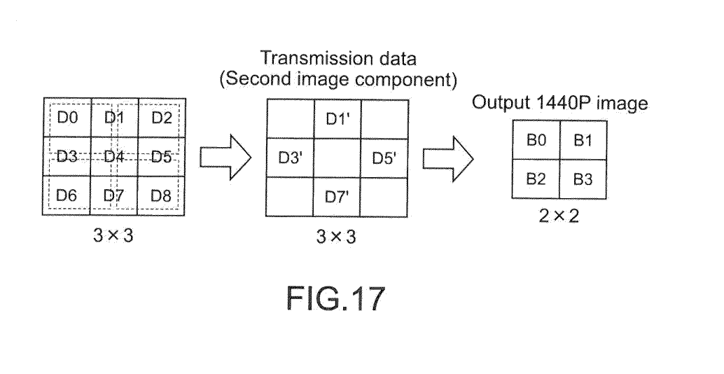

Firstly, description will be given on the generation of the 1440P image 91. FIG. 17 is a diagram showing how to use the pixels of the input image for the 1440P image as the output image according to the segmentation indicated by dotted lines.

On the left-hand side of FIG. 17, the array of 3×3 pixels of the input image is shown. By the following expressions, values of the pixels D1′, D3′, D5′, and D7′ in the transmission data (second, image component) shown at the center of FIG. 17 are obtained.

D1′={D0+(D1+D3)/2+D4/4}×4/9 (75)

D3′={D2+(D1+D5)/2+D4/4}×4/9 (76)

D5′={D6+(D3+D7)/2+D4/4}×4/9 (77)

D7′={D8+(D7+D5)/2+D4/4}×4/9 (78)

As shown on the right-hand side of FIG. 17, pixel positions are rearranged based on the above-mentioned second image component transmitted to the decoding apparatus so that the values of the pixels B0 to B3 are calculated. The pixels B0 to B3 form the 2×2 pixels of the 1440P image as the output image.

B0=D1′ (79)

B1=D3′ (80)

B2=D5′ (81)

B3=D7′ (82)

The above is the generation method for the 1440P image 91.

(Calculation of 2160P Image)

Next, description will be given on the restoration of the 2160P Image 70. Calculations are performed similarly on the first quadrant to the fourth quadrant, and therefore calculations on only the first quadrant will be described here.

Firstly, the value of the pixel D14 is obtained by the following expression based on the expression (2).

D14=D14′ (83)

Further, the third image component is the pixel D15 (pixel D5) of the 2160P image as the input image, and thus the value of the pixel D15 is obtained by the following expression.

D15=D15′ (84)

The value of the pixel D18 is obtained by the following expression based on the expression (6).

D18=D18′ (85)

The value of the pixel D12 is obtained by the following expression based on the expression (4).

D12=2×D12′−D15 (86)

The value of the pixel D17 is obtained by the following expression based on the expression (78).

D17=(D17′×9/4−D14/4−D15/2−D18)×2 (87)

The value of the pixel D16 is obtained by the following expression based on the expression (5).

D16=D16′×2—D17 (88)

The value of the pixel D11 is obtained by the following expression based on the expression (76).

D11=(D13′×9/4−D14/4−D15/2−D12)×2 (89)

The value of the pixel D13 is obtained by the following expression based on the expression (77).

D13=(D15′×9/4−D14/4−D17/2−D16)×2 (90)

The value of the pixel D10 is obtained by the following expression based on the expression (75).

D10=D11′×9/4−(D11+D13)/2−D14/4 (91)

By the above calculations, the values of the nine pixels in the first quadrant are obtained. After the values of the pixels in the second quadrant to the fourth quadrant are obtained in the same manner, the 2160P image 70 can be restored,

[Calculation of Offset Value]

In this embodiment, in the 3×3 pixel group, differences between the pixel D4′ of the base image and each of the pixels D0′, D2′, D6′, and D8′ of the first image component and between the pixel D4′ of the base image and the pixels D1′, D3′, D5′, and D7′ of the second image component are obtained. Additionally, a difference between the pixel D4′ of the base image and the pixel D5′ of the third image component is also obtained.

Hereinafter, description will be given on how actual calculation expressions are changed when the calculations of offset values are included in the calculation expressions between pixels for down-conversion described above. It should be noted that the 720P image and the 1080P image are the same as those in the first embodiment and therefore description thereof will be omitted.

(Calculation of 1440P Image)

Next, calculation expressions used when the 1440P image 91 is generated are shown as follows. Firstly, the second image component is calculated as follows.

D1′={D0+(D1+D3)/2+D4/4}×4/9−D4′ (92)

D3′={D2+(D1+D5)/2+D4/4}×4/9−D4′ (93)

D5′={D6+(D3+D7)/2+D4/4}×4/9−D4′ (94)

D7′={D8+(D7+D5)/2+D4/4}×4/9−D4′ (95)

Then, the values of the pixels B0 to B3 that form the 2×2 pixels of the 1440P image 91 as the output image are as follows.

B0=D1′+D4′ (96)

B1=D3′+D4′ (97)

B2=D5′+D4′ (98)

B3+D7′+D4′ (99)

The above is the calculation method for the 1440P image 91.

(Calculation of 2160P Image)

Next, the restoration of the 2160P Image 70 will be described. Since the same calculations are performed for the first to fourth quadrants, only the first quadrant is described here.

Firstly, the value of the pixel D14 is obtained by the following expression based on the expression (2).

D14=D14′ (100)

Further, the third image component is the pixel D15 (pixel D5) of the 2160P image as the input image, and thus the value of the pixel D15 is obtained by the following expression.

D15=D15′+D14′ (101)

The value of the pixel D18 is obtained by the following expression based on the expression (48).

D18−D18′+D14′ (102)

The value of the pixel D12 is obtained by the following expression based on the expression (46).

D12=2×(D12′+D14′)−D15 (103)

The value of the pixel D17 is obtained by the following expression based on the expression (95).

D17={(D17′+D14′)×9/4−D14/4−D15/2−D18}×2 (104)

The value of the pixel D16 is obtained by the following expression based on the expression (47),

D16=(D16′+D14′)×2−D17 (105)

The value of the pixel D11 is obtained by the following expression based on the expression (93).

D11=−{(D13′+D14′)×9/4−D14/4D15/2D12}×2 (106)

The value of the pixel D13 is obtained by the following expression based on the expression (94).

D13={(D15′+D14′)×9/4−D14/4−D17/2−D16)×2 (107)

The value of the pixel D10 is obtained by the following-expression based on the expression (92).

D10=(D11′+D14′)×9/4−(D11+D13)/2−D14/4 (108)

By the above calculations, the values of the nine pixels in the first quadrant are obtained. After the values of the pixels in the second quadrant to the fourth quadrant are obtained in the same manner, the 2160P image 70 can be restored.

[Rearrangement of Pixels of Transmission Data]

As to the pixel rearrangement method for the transmission data, the rearrangement of the base image and the first and second, image components is the same as that of the first embodiment. In addition thereto, the third, image component is added to the transmission data in this embodiment,

[Configuration of Encoding Apparatus]

Next, a configuration of the encoding apparatus 101 will be described. A block diagram showing the configuration of the encoding apparatus 101 is the same as the block diagram of FIG. 9 and therefore illustration thereof is omitted.

The difference from the first embodiment is a generation unit 111. The generation unit 111 performs the ⅓-fold down-conversion on a 4K high-definition image (2160P image 10) to generate a base image (720P image 20) as described above. The generated, base image is passed to the offset calculation unit 120 and the transmission unit 140. Further, the generation unit 111 performs the ½-fold down-conversion on the 4K high-definition image (2160P image 10) to a midpoint of the processing to generate the first image component as described above. This is the same as in the first embodiment.

The difference from the first embodiment in the generation unit 111 is as follows. The generation unit 111 performs the ⅔-fold, down-conversion on the 4K high-definition image (2160P image 10) to generate the second image component, and performs the ⅓-fold down-conversion on the 4K high-definition image (2160P image 10) by thinning-out to generate the third image component.

The generated first, second, and third, image components are passed to the offset calculation unit 120 for processing, and then transmitted to the decoding apparatus 201 as the transmission data, together with the base image.

[Configuration of Decoding Apparatus]

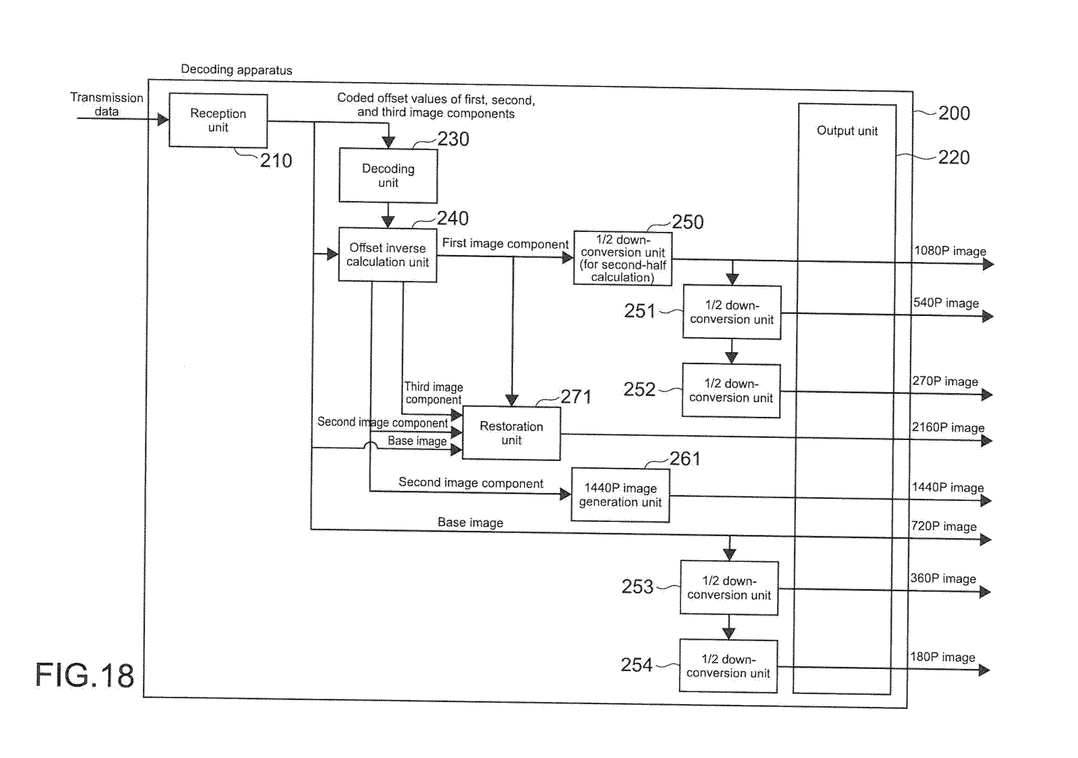

Next, a configuration of the decoding apparatus 201 will be described. FIG. 18 is a block diagram showing the configuration of the decoding apparatus 201.

The decoding apparatus 201 includes a reception unit 210, an output unit 220, a decoding unit 230, an offset inverse calculation unit 240, a ½ down-conversion unit (for second-half calculation) 250, ½ down-conversion units 251, 252, 253, and 254, a 1440P image generation unit 261, and a restoration unit 271.

The large difference from the first embodiment is the 1440P image generation unit 261 and the restoration unit 271.

The 1440P image generation unit 261 rearranges the pixel, values at the pixel positions of the pixels B0 to B3 of the 2×2 pixel group. Specifically, as described above, those pixel values are obtained by the encoding apparatus 101 performing the ⅔-fold down-conversion on the 2160P image 10, and then stored at positions of the pixels D1′, D3′, D5′, and D7′ of the 3×3 pixel group.

The restoration unit 271 restores the 2160P image 70 by solving the simultaneous equations based on the base image and the first, second, and third image components transmitted from the encoding apparatus 101 as described above.

Hereinabove, the second embodiment of the present disclosure has been described,

### Third Embodiment

Next, a third embodiment of the present disclosure will be described. It should be noted that in the following description, only a difference from the first embodiment will be described.

[Difference from First Embodiment (Outline)]

In the first embodiment, in order to obtain the 720P image 20, the pixels other than the pixel D4 in the pixels D0 to D8 are thinned out to perform the ⅓-fold down-conversion processing. In this embodiment, the ⅓-fold down-conversion processing is performed by not thinning out the pixels but calculating an average value of the pixels D0 to D8.

Specifically, in the first embodiment, the value of the pixel D4′ is as expressed in the expression (1).

D4′=D4 (1)

In this embodiment, however, the value of the pixel D4′ is as follows.

D4′−(D0+D1+D2+D3+D4+D5+D6+D7+D8)/9 (109)

As found in the expression (109), the value of the pixel D4 is not determined uniquely from this expression. Therefore, when the simultaneous equations are solved in order to restore the 2160P image, a value of another pixel, e.g., the value of the pixel D5 has to be transmitted to a decoding apparatus 202 as the third image component, as in the second embodiment.

[Calculation for Down-Conversion (Outline)]

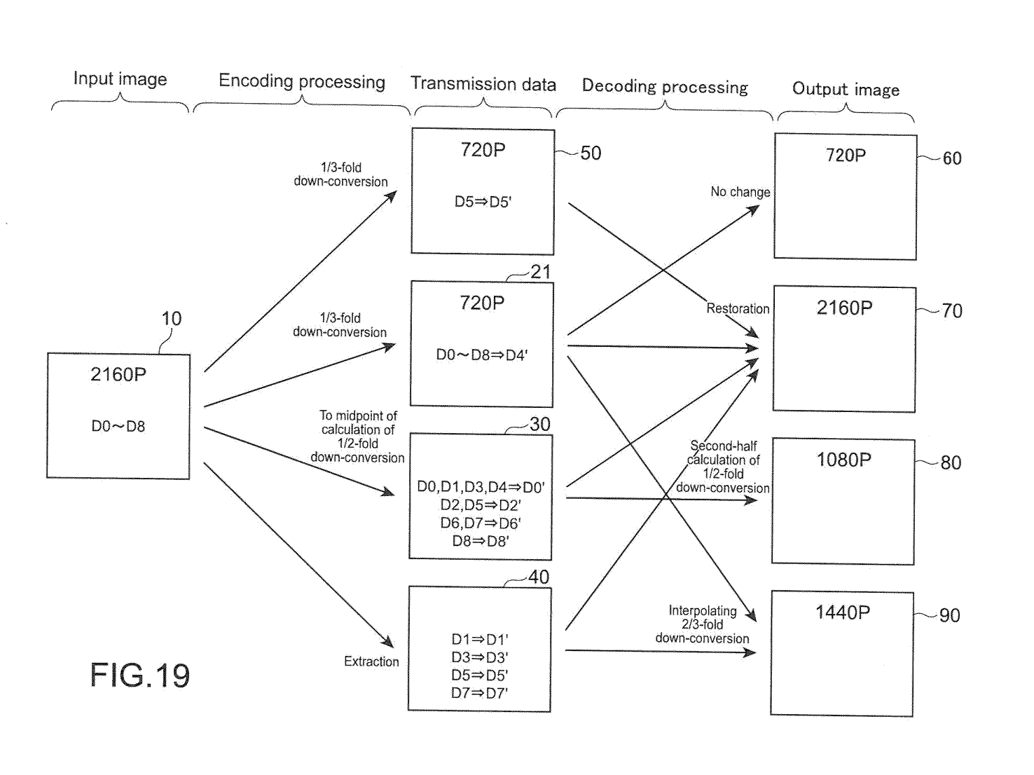

FIG. 19 is a diagram showing processing in this embodiment, through which an image input into an encoding apparatus 102 is output from the decoding apparatus 202 as output images with respective resolutions.

A first difference from the first, embodiment is in that the pixel D4′ forming the base image (720P image) is obtained using the pixels D0 to D8. A second difference from the first embodiment is in that the third image component 50 formed of the pixel D5, for example, is included in the transmission data. A third difference from the first embodiment is in that the base image 21 and the first, second, and third image components 30, 40, and 50 are used to restore the 2160 P image.

It should be noted that the details of calculations by expressions and the details of the encoding apparatus 102 and the decoding apparatus 202 are derived from the first embodiment and the second embodiment similarly, and therefore description thereof will be omitted.

It should be noted that in the third embodiment, the calculation expression of the pixel D4′ is changed from the expression (1) to the expression (109) based on the first embodiment, but the calculation expression is not limited thereto. The calculation expression of the pixel D4′ may be changed to the expression (109) based on the second embodiment.

[Supplementary Note]

Additionally, the present disclosure is not limited to the above-mentioned embodiments and can be variously modified without departing from the gist of the present disclosure as a matter of course.

It should be understood, by those skilled in the art that various modifications, combinations, sub-combinations and alterations may occur depending on design requirements and other factors insofar as they are within the scope of the appended claims or the equivalents thereof.

What is claimed is:

1. An encoding apparatus, comprising:
a base image generation unit configured to down-convert an input image at a predetermined first magnification to generate a base image;
a first image component generation unit configured to generate first image component information, the first image component information being used to down-convert the input image at a predetermined second magnification that is different from the first magnification and being part of information used to restore the input image from the base image;
a second image component generation unit configured to generate second, image component information, the second image component information being used to down-convert the input image at a predetermined third magnification that is different from the first magnification and the second magnification and being used together with the first image component information to restore the input image from the base image; and
an output unit configured to output the base image, the first image component Information, and the second image component information.

2. The encoding apparatus according to claim 1, further comprising
a coding unit configured to
calculate a first offset value between the first image component information and each pixel of the base image to code the first offset value, and
calculate a second offset value between the second image component information and each pixel of the base image to code the second offset value, wherein
the output unit is configured to output the base image, the coded first offset value, and the coded second offset value.

3. The encoding apparatus according to claim 2, further comprising
an image quality adjustment unit configured to uniformly adjusting an image quality for all pixels of the base image, wherein
the coding unit is configured to calculate the first offset value and the second offset value from the base image with an adjusted image quality.

4. The encoding apparatus according to claim 1, wherein
the input image has a vertical resolution of 2160,
the first magnification is ⅓-fold,
the second magnification is ½-fold, and
the third magnification is ⅔-fold.

5. A decoding apparatus, comprising:
an input unit configured to input
a base image obtained by down-converting an original image at a predetermined first magnification,
first image component information used to down-convert the original image at a predetermined second magnification that is different from the first magnification, the first image component information being part of information used to restore the original image from the base image, and
second image component information used to down-convert the original image at a predetermined third magnification that is different from the first magnification and the second magnification, the second image component information being used together with the first image component, information to restore the original image from the base image; and
an output unit configured to output the input base image.

6. The decoding apparatus according to claim 5, wherein
the base image output from the output unit has a vertical resolution of 720.

7. A decoding apparatus, comprising:
an input unit configured to input
a base image obtained by down-converting an original image at a predetermined first magnification,
first image component information used to down-convert the original image at a predetermined second magnification that is different from the first magnification, the first image component information being part of information used to restore the original image from the base image, and
second image component information used to down-convert the original image at a predetermined third magnification that is different from the first magnification and the second magnification, the second image component information being used together with the first image component information to restore the original image from the base image;
a down-conversion unit configured to generate a down-converted image corresponding to the original image down-converted at the second magnification by using the input first image component information; and
an output unit configured, to output the down-converted image.

8. The decoding apparatus according to claim 7, wherein
the image output from the output unit has a vertical resolution of 1080.

9. A decoding apparatus, comprising:
an input unit configured to input
a base image obtained by down-converting an original image at a predetermined first magnification,
first image component information used to down-convert the original image at a predetermined second magnification that is different from the first magnification, the first image component information being part of information used to restore the original image from the base image, and
second image component information used to down-convert the original image at a predetermined third magnification that is different from the first magnification and the second magnification, the second image component information being used together with the first image component information to restore the original image from the base image;
a down-conversion unit configured to generate a down-converted image corresponding to the original image down-converted at the third magnification by using the input base image and the input second image component information; and
an output unit configured to output the down-converted image.

10. The decoding apparatus according to claim 9, wherein
the image output from the output unit has a vertical resolution of 1440.

11. A decoding apparatus, comprising:
an input unit configured to input
a base image obtained by down-converting an original image at a predetermined first magnification,
first image component information used to down-convert the original image at a predetermined second magnification that is different from the first magnification, the first image component information being part of information used to restore the original image from the base image, and
second image component information used to down-convert the original image at a predetermined third magnification that is different from the first magnification and the second magnification, the second image component information being used together with the first image component, information to restore the original image from the base image;
a restoration unit configured to restore the original image by using the input base image, the input first image component information, and the input second image component information; and
an output unit configured to output the restored original image.

12. The decoding apparatus according to claim 11, wherein
the image output from the output unit has a vertical resolution of 2160.

13. A decoding apparatus, comprising:
an input unit configured to input
a base image obtained by down-converting an original image at a predetermined first magnification,
first image component information used to down-convert the original image at a predetermined second magnification that is different from the first magnification, the first image component information being part of information used to restore the original image from the base image, and
second image component information used to down-convert the original image at a predetermined third magnification that is different from the first magnification and the second magnification, the second image component information being used together with the first image component information to restore the original image from the base image;
a first down-conversion unit configured to generate a first down-converted image corresponding to the original image down-converted at the second magnification by using the input first image component information;
a second down-conversion unit configured to generate a second down-converted image corresponding to the original image down-converted at the third magnification by using the input base image and the input second image component information;
a restoration unit configured to restore the original image by using the input base image, the input first image component information, and the input second image component information; and
an output unit configured to output the input base image, the first down-converted image, the second down-converted image, and the restored original image.

14. The decoding apparatus according to claim 13, wherein
the base image output from the output unit has a vertical resolution of 720,
the first down-converted image has a vertical resolution of 1080,
the second down-converted image has a vertical resolution of 1440, and
the restored original image has a vertical resolution of 2160.

15. An encoding method, comprising:
down-converting an input image at a predetermined first magnification to generate a base image;
generating first image component information, the first image component information being used to down-convert the input image at a predetermined second magnification that is different from the first magnification and being part of information used to restore the input image from the base image; and
generating second image component information, the second image component information being used to down-convert the input image at a predetermined third magnification that is different from the first magnification and the second magnification and being used together with the first image component information to restore the input image from the base image.

16. A decoding method, comprising:
receiving
a base image obtained by down-converting an original image at a predetermined first magnification,
first image component information used to down-convert the original image at a predetermined second magnification that is different from the first magnification, the first image component information being part of information used to restore the original image from the base image, and
second image component information used to down-convert the original image at a predetermined third magnification that is different from the first magnification and the second magnification, the second image component information being used together with the first image component information to restore the original image from the base image;
generating a down-converted image corresponding to the original image down-converted at the second magnification by using the first, image component information;
generating a down-converted image corresponding to the original image down-converted at the third magnification by using the base image and the second image component information; and
restoring the original image by using the base image, the first image component information, and the second image component information.
